(19) United States
(12) Patent Application Publication
(10) Pub. No.: US 2006/0248197 A1
(43) Pub. Date: Nov. 2, 2006

(54) Adaptive connectionless scheduling protocol

(76) Inventors: Scott Charles Evans, Burnt Hills, NY (US); Harold Woodruff Tomlinson JR., Scotia, NY (US); Nick Andrew Van Stralan, Ballston, NY (US); John Erik Hershey, Ballston Lake, NY (US); Michael James Hartman, Clifton Park, NY (US)

Correspondence Address: Patrick S. Yoder;FLETCHER YODER, P.O. Box 692289, Houston, TX, 77269-2289, US

(21) Appl. No.: 11/116,915

(22) Filed: Apr. 27, 2005

(51) Int. Cl. G06F 15/16

(52) U.S. Cl. 709/227

(57) ABSTRACT

A system for transmitting messages among a plurality of nodes is provided. The system includes a media access scheduler for pseudorandomly scheduling discrete message start times for each node of the plurality of nodes to provide access to a shared medium. A method of minimizing power in a distributed network and a method of operating the distributed network is also provided.

### STATEMENT REGARDING FEDERALLY SPONSORED RESEARCH & DEVELOPMENT

This invention was made with Government support under contract number NBCHC030098 awarded by DARPA. The Government has certain rights in the invention.

### BACKGROUND

The invention relates generally to the field of wireless networks, and more particularly, to energy minimization in wireless sensor networks.

Sensor nodes may be dispersed over locations and areas for various purposes, such as detection and communication of events and activities of interest. In one system of sensor nodes, each node contains one or several types of sensors and is capable of radio frequency (rf) communications. Moreover, these nodes may contain signal processing engines both for processing the data prior to transmission and for managing the networking protocols. The nodes create a self-organizing network, and are capable of cooperative functions such as beamforming and cooperative communications. Low power operation is critical in such an application, as the nodes operate using small batteries.

One conventional method of minimizing energy draw in such sensor nodes is by reducing receiver on-time duty cycle. However, reduction of receiver on-time presents challenges such as routing, discovery, and latency because both transmitters and receivers must be synchronized to be on at the same time in order to avoid wasted messaging. This leads to additional power utilization. A typical method of avoiding wasted messaging is to have neighboring nodes to have similar wake and sleep schedules. However, such methods can lead to channel contention, collisions and increased latency.

Another conventional method is to exploit redundant nodes by turning on only a time-varying subset of nodes, where the subset is selected for desired sensor and radio coverage. The remaining nodes may be powered down, only to be awakened to provide additional sensor readings or communication routes when data transmission or sensing is required. However, one problem associated with such a distributed shut down scheme is the strategy to select which node to shut down and which to turn on at any given instant.

Therefore, a system and method for energy minimization in wireless sensor networks is desired.

### SUMMARY

In accordance with one aspect of the present technique, system for transmitting messages among a plurality of nodes is provided. The system includes a media access scheduler for pseudorandomly scheduling discrete message start times for each node of the plurality of nodes to provide access to a shared medium. A method of minimizing power in a distributed network and a method of operating the distributed network is also provided.

These and other advantages and features will be more readily understood from the following detailed description of preferred embodiments of the invention that is provided in connection with the accompanying drawings.

### BRIEF DESCRIPTION OF THE DRAWINGS

FIG. 1 is a schematic diagram of a distributed network in accordance with aspects of the present technique.

FIG. 2 is a graphical view of energy consumption in the distributed network of FIG. 1 in accordance with aspects of the present technique.

FIG. 3 is a diagrammatical view illustrating a message schedule based upon start time in accordance with aspects of the present technique.

FIG. 4 is a schematic diagram illustrating a scheduled transmission and a scheduled reception of a message based on a geographical mapping in accordance with aspects of the present technique.

FIG. 5 is a schematic diagram illustrating scheduled mapping of transmission and reception times of a message in accordance with aspects of the present technique.

FIG. 6 is a flowchart illustrating scheduling based on network load in accordance with aspects of the present technique.

FIG. 7 is a schematic diagram illustrating an exemplary pseudorandom scheduling approach in accordance with aspects of the present technique.

FIG. 8 is a diagrammatical view illustrating movement of the relative start times assigned to a given node to different parts of subsequent frames in accordance with aspects of the present technique.

FIG. 9 is a schematic diagram illustrating boomerang acknowledgements generated in accordance with aspects of the present technique.

FIG. 10 is a flow chart illustrating an energy management process during reception of a message in accordance with one aspect of the present technique.

FIG. 11 is a flow chart illustrating an energy management process during transmission of a message in accordance with one aspect of the present technique.

### DETAILED DESCRIPTION OF EXEMPLARY EMBODIMENTS

In the subsequent paragraphs, an approach for scheduling receiver and transmitter message start times (MSTs) based on a unique identifier, such as geographic position or unique identification number, will be explained in detail. The approach described hereinafter enables sensor nodes that are adapted to receive to be powered up for a minimum amount of time while still enabling low latency communications over a wide range of data rates and traffic patterns, and promotes total system energy reduction through harnessing energy gains in routing, discovery and messaging. The various aspects of the present technique will be explained, by way of example only, with the aid of figures hereinafter.

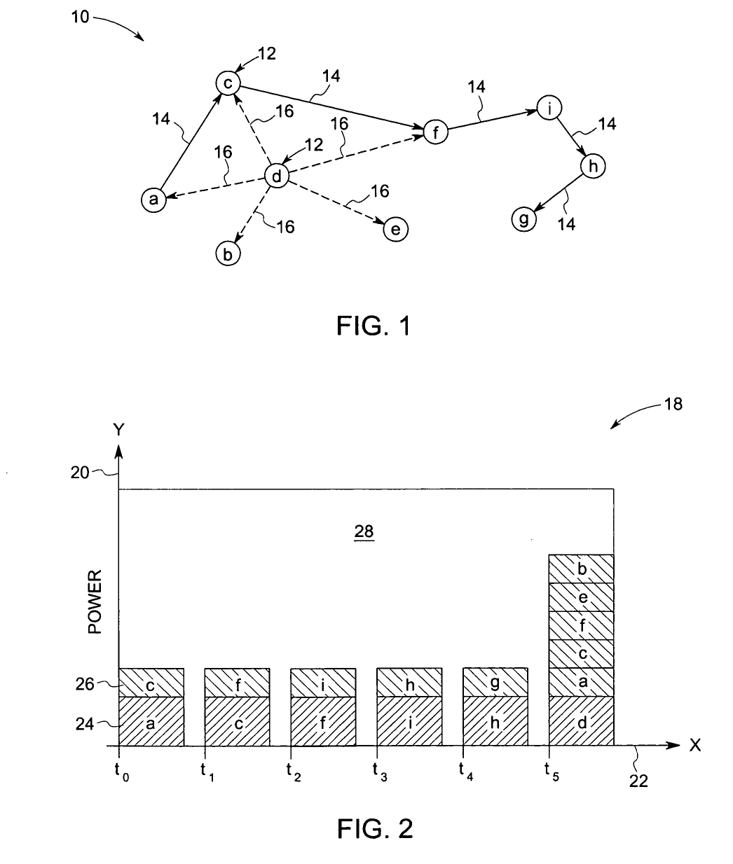

Referring generally to FIG. 1, an adaptive scheduling protocol for minimizing energy consumption in a distributed network will be described by reference to a distributed network designated generally by numeral 10. It should be appreciated; however, that the adaptive scheduling protocol may find application in a range of settings and systems, and that its use in the distributed network of sensor nodes shown is but one such application. Similarly, while “sensor nodes” are described generally here, those skilled in the art will recognize that any of a great variety of devices may employ the present techniques, which is in no way limited to devices that merely detect and measure a physical parameter.

The distributed network 10 includes a plurality of sensor nodes designated generally by numeral 12, which may be operable to sense certain parameters from an environment. The distributed network 10 may follow a unicast transmission 14, wherein each sensor node 12 is configured to transmit to a single intended sensor node 12. For example, the unicast transmission 14 follows a path starting from sensor node a to sensor node g via sensor nodes c, f, i, and h. Similarly, the distributed network 10 may follow a multicast transmission 16, wherein each sensor node 12 is configured to transmit to multiple sensor nodes 12. For example, the multicast transmission 16 illustrated in FIG. 1 follows paths starting from sensor node d to sensor nodes a, b, c, e, and f.

The distributed network 10 may further include an actuating mechanism that activates the sensor nodes 12 for detecting the parameters. The raw signals, such as detections and measurements, may be forwarded to a processing center with or without any pre-processing using unicast transmission 14 or multicast transmission 16. Therefore, for sensing applications, these sensor nodes 12 are also operable to transmit and receive the detected and/or measured parameters. In other words, these sensor nodes 12 operate as transmitters, or receivers, or both in a time-multiplexed fashion. Thus, in the following description, sensor nodes 12 may be alternatively referred to as transmitters, node transmitters, receivers, node receivers, node, or transceivers 12, all of which are considered within the scope of the techniques described.

Referring now to FIG. 2, a graphical illustration 18 of energy consumption in the distributed network 10 is shown. The illustration 18 shows the power consumed, on the y-axis 20 plotted against time on the x-axis 22. As illustrated, at time t₀, sensor node a awakens for transmission of a message packet and thereby consumes power as shown by block 24. At the same instant, sensor node c awakens for reception of the message packet from sensor node a, and consumes power as shown by block 26. Similarly, at times t₁, t₂, t₃, and t₄, sensor nodes c, f, i, and h awaken for transmission of the message packet to sensor nodes f, i, h, and g, respectively. Simultaneously, respective sensor nodes f, i, h, and g awaken for reception of the message packet broadcast from node d.

Therefore, the power required to convey a unicast message, for example a message packet originating at sensor node a to sensor node g via sensor nodes c, f, i, and h is a fraction of the power required to have all the sensor nodes 12 powered up, as shown generally by reference numeral 28. Similarly, multicast transmission from sensor node d to sensor nodes a, c, f, e, and b may be efficiently accomplished by scheduling at time t₅. Background 28 of the illustration 18 shows the average power required to have all node receivers 12 powered up with one transmitter 12 transmitting. Furthermore, the actual power gain from such a scheduling approach may be greater than illustrated because energy losses resulting from collisions and retransmissions are less likely in this scheduled approach that causes contiguous sensor nodes 12 to share a broadcast channel as compared to unscheduled schemes. By utilizing highly accurate synchronization and a highly accurate clock, an adaptive connectionless scheduling protocol that achieves near perfect scheduling and automatically adapts to load and topology conditions, as well as a highly flexible scheduling protocol for wireless sensor networks that minimizes energy use throughout the range of duty cycle operations may be accomplished.

For minimizing energy costs in distributed networks 10 while providing flexible use of bandwidth and minimum latency routes, the present technique makes use of predetermined global schedules for both scheduled receiver on-times (targeted for one-to-one transmissions from any sensor node 12 within range to intended receivers) and scheduled transmissions (designed for one-to-many transmission of messages of interest to multiple sensor nodes 12). These schedules may be determined by each node through algorithms based on parameters specific to each node 12, such as GPS positioning (global positioning system) or a unique identifier.

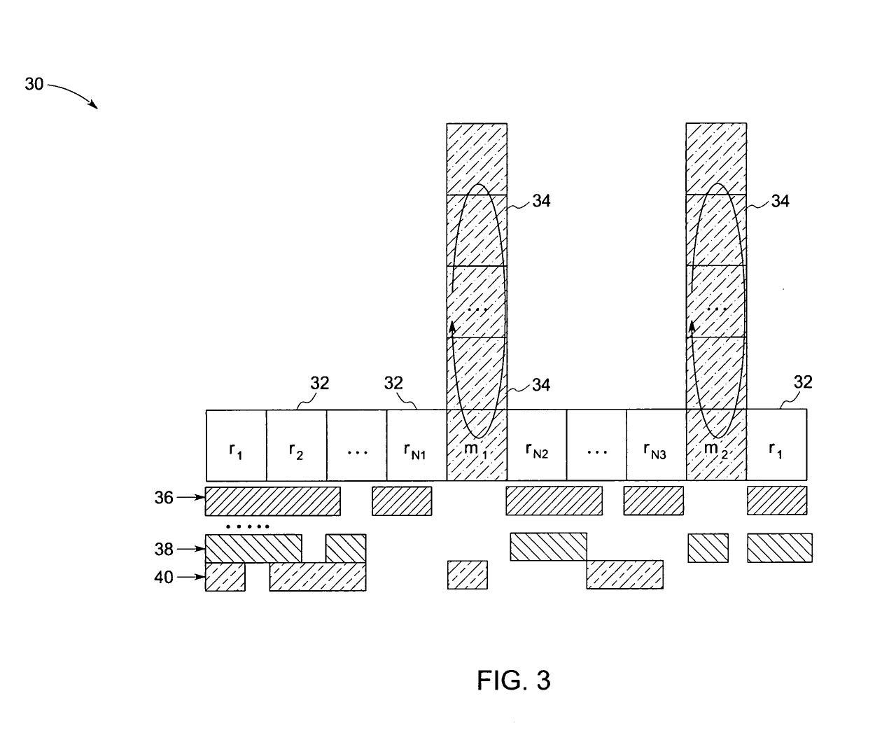

Referring to FIG. 3, a scheduling algorithm 30 is illustrated, where scheduled receiver on-times are represented by rᵢ 32 and scheduled one-to-many transmission times for a given sensor node i are represented by mᵢ and reference numeral 34. The receiver on-times rᵢ, indicated by reference numeral 32, represent the required interval during which a given sensor node 12 may be powered up to attempt to recognize the start of a message packet. Different CDMA (code division multiple access) message packets 36, 38, and 40 are shown beginning transmission at different instances. For example, one message packet in CDMA message packets 36 starts at receiver on-time r₁, while another message packet begins at receiver on-time r_{N2}. Packet transmissions of the different CDMA message packets 36, 38, and 40 in progress may continue longer than the required MSTs as shown in FIG. 3, providing flexibility for sharing bandwidth. Additionally, bandwidth flexibility may be achieved through schedules that assign multiple possible MSTs for reception and transmission. However, these use only a subset of the possible message slots in given modes.

Thus, the distributed network 10 employs use of scheduled receiver (unicast message) start times and interleaved scheduled transmitter (multicast message) start times, as illustrated in FIG. 3. Furthermore, a unique schedule may be assigned to a node based on location identifiers known in the art, such as GPS position or a unique identifier applied against a hashing function, and then this schedule may be utilized to achieve required performance while minimizing energy utilization. The adaptive scheduling allows overlapping of messages with receiver start times, based on latency requirements of the distributed network 10 and network load. This approach enables achieving bounded latency for the MSTs. Embodiments for assigning schedules to sensor nodes 12 will now be presented.

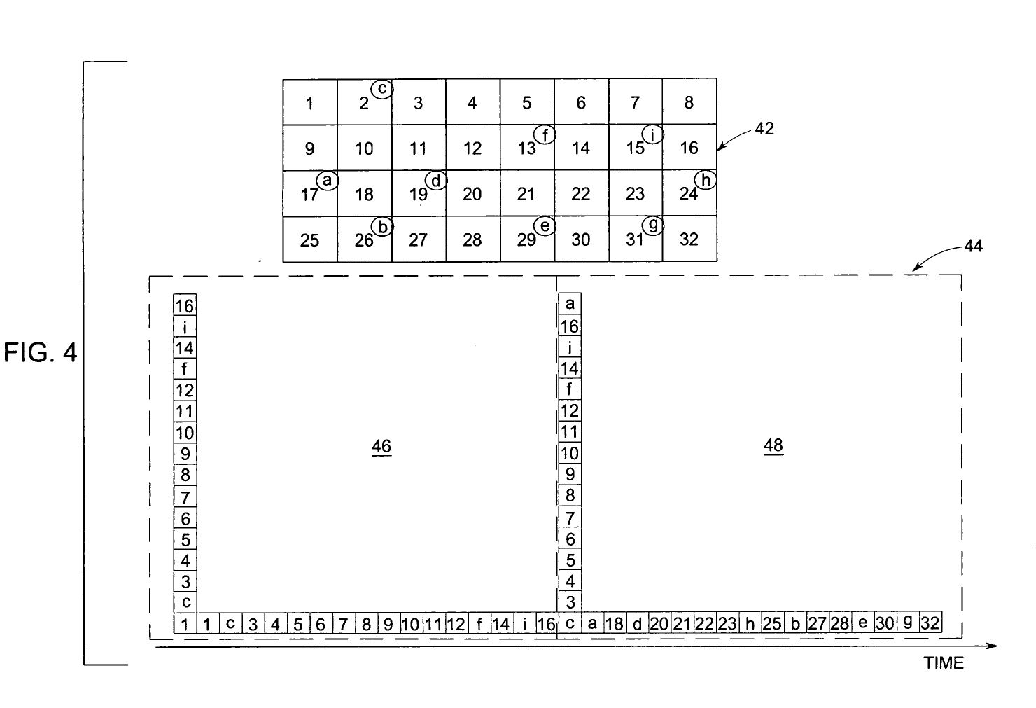

In one embodiment, geographic based schedule assignment may be utilized. FIG. 4 illustrates mapping of schedule time slots geographically. FIG. 4 illustrates a mapping matrix 42 of schedule time slots, and a predefined tiling 44 of schedule time slots. Based on the predefined tiling or quantization 44 of geographic positions, a sensor node schedule may be predetermined.

The mapping matrix 42 in FIG. 4 may be read as follows. Each of the numbers 1 through 32 represent successive time slots (e.g. t₁ to t₃₂), in which the sensor nodes 12 are given an opportunity to power up for transmission or reception. Each of the circled letters is representative of the respective sensor node 12. In other words, in the time slots t₁ to t₃₂ in the mapping matrix 42, scheduled receiver on-times and many-to-one scheduled transmission times are mapped against sensor nodes 12. If multiple sensor nodes 12 are contained within a predefined tiling 44, which follows the time slots and sensor nodes representation shown in mapping matrix 42, the sensor nodes 12 may share the time slots available in a round-robin fashion or adopt the time slots available to an unoccupied neighboring tile. The time-sharing in a round-robin fashion is represented by the vertical stacks in predefined tiling blocks 46 and 48. The horizontal stack in predefined tiling blocks 46 and 48 shows the successive time slots for power up condition for respective sensor nodes 12.

As illustrated in predefined tiling block 46, at time slot t₂, sensor node c transmits the scheduled transmission time required for the message packet as a multicast transmission. Interested sensor nodes 12 power up to receive the scheduled transmission time. Similarly, at time slots t₁₃ and t₁₅ in predefined tiling block 46, sensor nodes f and i transmit scheduled transmission times, respectively. Thus, tiling block 46 illustrates scheduled transmitter on-times for one-to-many message packet transmissions.

Again, at time slot t₂ in predefined tiling block 48, sensor node c transmits the scheduled transmission time required for the message packet as a multicast transmission, while sensor nodes b, e, and g power up to receive messages at times t₂₆, t₂₉, and t₃₁ respectively. Thus, tiling block 48 illustrates scheduled receiver on-times for one-to-one message packet transmissions. Furthermore, each of the nodes 12 may switch scheduling of the MSTs between a transmission mode, during which the node 12 may schedule transmission MSTs, and a reception mode, in which the node 12 may schedule receiver MSTs. Thus, each of the sensor nodes 12 is capable of adapting from a unicast mode to a multicast mode (or to a broadcast mode), and vice versa, as required by the network 10.

Assigning schedules based on geographic position has several advantages. For example, an effective reuse scheme may be implemented, such that assigned MSTs may be duplicated at sufficient distance to ensure there is no interference. Moreover, GPS positioning may be easily implemented, and GPS facilitates synchronization to a high accuracy clock at low energy. Furthermore, MSTs may be synchronized so that low latency paths exist in preferred directions, such as directed towards or originating from the sensor node 12. In addition, the MSTs may achieve bounded latency. Alternatively, clock synchronization may be achieved by utilizing synchronization protocols known in the art, such as Network Time Protocol (NTP), Timing-sync Protocol for Sensor Networks (TPSN), Reference Broadcast Synchronization (RBS), Flooding Time Synchronization Protocol (FTSP), Time-stamp synchronization (TSS), and the like. Moreover, clock synchronization may be achieved by mutual sharing of clock frequency between the various nodes 12 in the distributed network 10. In other words, if a node 12 seeks synchronization of its clock, it may interrogate the other nodes 12 within the distributed network 10 for clock frequency and/or clock signal.

If node position is utilized to determine a node's unique schedule, a grid tile size that prevents multiple nodes from sharing a tile is desirable. This will imply that many schedules are not utilized, but that may not reduce total network capacity because the schedule corresponds only to MSTs, and packet length may spill over into any number of adjacent MSTs. Thus, in one embodiment, a free space range between transceivers of 100 to 1,000 meters may be implemented. Further, a geographic partitioning may be constructed such that it would be unlikely that multiple sensor nodes 12 share the same tile. However, if multiple sensor nodes 12 do share the same tile, time slots of an adjacent tile region may be assumed in an adaptive manner. Similarly, MSTs of the various nodes 12 may be shared by other nodes 12 in the network based on the bandwidth requirement (or throughput of the network), latency requirement, or distance between the nodes.

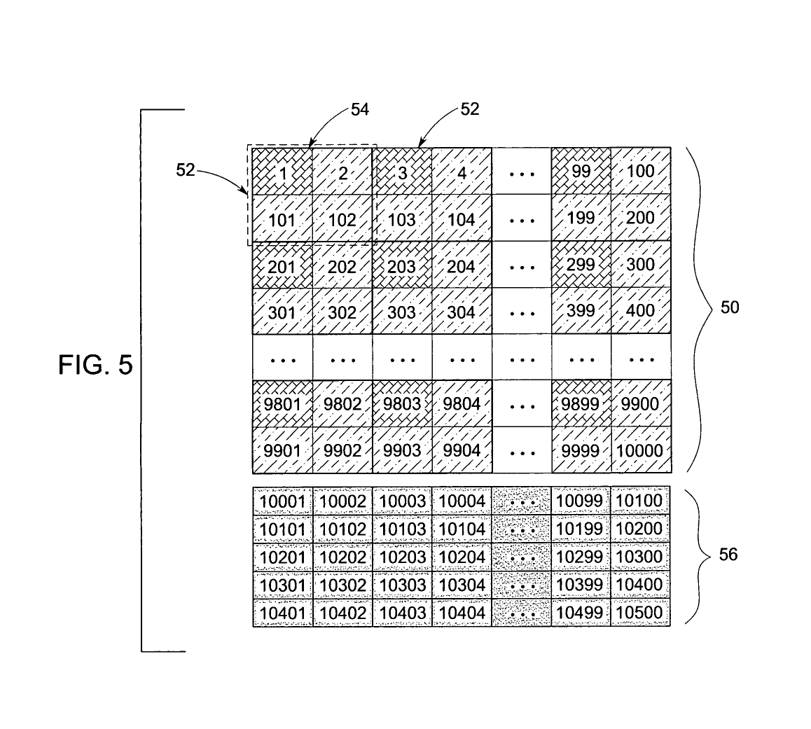

FIG. 5 shows a geographic-based schedule mapping assigning 10,500 MSTs to 2,500 unique schedules. A grid generally designated by reference numeral 50 of dimension 100 by 100 may be constructed as shown in FIG. 5, with each tile numbered. Each tile region 52 consisting of four squares may be mapped to a geographic region, for example, of 50 by 50 meters. It may be noted that these message slots may be implemented in a rectangular grid, or a different grid format, such as a hexagonal grid. Thus, each tile region 52 corresponds to a geographic area of 2,500 square meters. This provides a reuse distance of 2.5 square kilometer. In other words, in the illustrated implementation, the schedule (message slot assignments) will repeat themselves at distances of 2.5 square kilometer. The time slot represented by the upper left tile in a given 2 by 2 tile region 52 (e.g., time slot represented by 1 in tile region 54 that includes time slots 1, 2, 101, and 102) corresponds to the default receiver on-time slot. The other three slots (e.g., time slots 2, 101, and 102 in tile region 54) may be configured to function as either additional one-to-many scheduled transmission slots or additional receiver on-time slots, for using channel capacity effectively in the distributed network 10. In this manner, 10,000 MST slots are mapped to 2,500 square geographical areas. Furthermore, as shown in FIG. 5, five hundred time slots 56, (10,001 through 10,500) may be mapped to geographic positions in a predetermined manner for scheduled one-to-many transmissions. Additional schedule mappings are possible, and any number of assigned MSTs may be assigned to a given node 12, with subsets of the total available assigned MSTs being used for receiving or transmitting messages as needed for a given traffic or network load condition. The number of MSTs utilized, and the nature of the MST (either transmission or receiver on-time) can be conveyed to neighboring nodes 12 through separate unicast transmissions, broadcast summary, or information carried with a packet string in a header field.

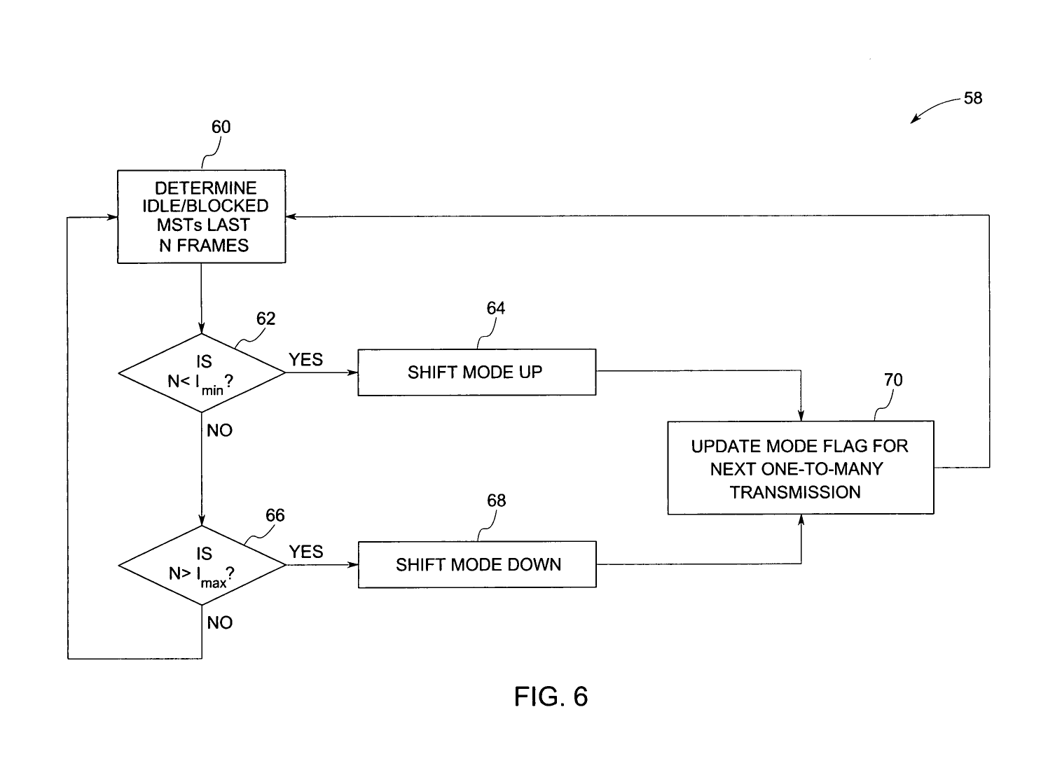

The number of MSTs utilized may also be determined adaptively based on the number of idle MSTs as shown in FIG. 6. FIG. 6 is a flowchart 58 illustrating scheduling based on network load. As illustrated, an idle or blocked MST's last N frames may be determined at block 60. If the last N frames are less than a lower threshold value at block 62, such as Iₘᵢₙ (i.e. N<Iₘᵢₙ), then the transmission mode may be shifted up, for example from 4 MST/sec to 8 MST/sec (block 64). However, if it is not, then the last N frames are checked to determine whether the last N frames are greater than a higher threshold value at block 66, such as Iₘₐₓ (i.e. N>Iₘₐₓ). If so, the transmission mode may be shifted down, for example from 8 MST/sec to 2 MST/sec (block 68). If the last N frames are not greater than the higher threshold value at block 66, then the idle or blocked MSTs last N frames may be again determined from block 60. Once the mode is altered at block 64 or 68, the mode flag may be updated for the next one-to-many transmission (block 70), and the process may proceed to determining the last N frames again from block 60.

Continuing with the exemplary implementation of FIG. 5, for a nominal time frame of 1 second, each MST is 1/10,500 seconds (95.2 microseconds) in duration. Thus, with the above-mentioned mapping, each sensor node 12 assigned with a unique schedule will power up to receive messages for one 95.2 microsecond interval each second, and transmit information (such as routing information or other data that may be of interest to multiple neighboring sensor nodes 12) once every 5 seconds. Through the scheduling algorithm and some distinguishing feature of neighboring sensor nodes 12, such as GPS position or a unique identifier, each sensor node 12 may distinguish the reception and transmission schedules of its neighboring sensor nodes 12. Therefore, it is responsible to power up at the appropriate time to transmit during an intended receiver's scheduled on-time. Message packet sizes may be altered to achieve desired data rate by exceeding the required MST interval, with minimal energy expense from sensor nodes 12 that are blocked by the occupied channel, since they occur only periodically. Thus, this approach features utilization of most of the assigned MSTs in a frame for reducing the interval between MSTs, thereby increasing bandwidth availability and improving latency. In other words, many scheduled MSTs may be available to each sensor node 12 in the distributed network 10 within a frame, but only a subset of these scheduled MSTs may be utilized. Moreover, a sensor node 12 may utilize more of the available scheduled MSTs when needed, and may thereafter reduce the number of scheduled MSTs utilized, as the need for bandwidth diminishes. This could further save power consumed by the node in an adaptive manner. The “short” MST intervals used allow sensor nodes 12 to sleep, based on clock accuracy across the network, time of flight ambiguity, and the amount of time a receiver node requires to detect a message.

In another embodiment, a unique identifier-based scheduling (or a pseudorandom scheduling) assignment may be implemented if a geographic-based scheme is not desired or practical. A simple hashing function from a set of unique identifiers to the set of unique schedules facilitates this mapping. If two sensor nodes 12 within range are mapped to the same schedule, this can be known during the discovery process, and one of the sensor nodes 12 may follow a different schedule. For example, the geographic position based schedule described above may be mapped from a unique 64-bit identifier instead of utilizing geographic positioning, by randomly mapping 64-bit numbers into S distinct bins numbered 1 to S. A block cipher function, such as Data Encryption Standard (DES), may be utilized in a hashing function for implementation. The DES may be operated in an Electronic Codebook (ECB) confidentiality mode. In the ECB mode, a one-to-one mapping of input words to output words may be performed by inputting the processor with any one of its keying variables from 2⁵⁶ keying variables.

For example, the hashing function may proceed by entering a 64-bit unit address (in this case, there would be 2⁶⁴ keying variables) into the input word register of the DES keyed with a keying variable K and encrypting the keying variable K. The 64-bit output word is composed of bits b₁, b₂, . . . , b₆₄. The output word may then be converted to a number N, where 0≦N≦1 by calculating N=2⁻¹·b₁+2⁻²·b₂+ . . . +2⁻⁶⁴·b₆₄. N may then be scaled to produce a uniformly distributed number s, where 1≦s≦S. by forming s=fix(N·S)+1. Changing a single bit in the input word results in each output bit being inverted with probability ½. Similarly, if a different keying variable is used, changing a single keying variable bit results in each bit in the output word to be inverted with probability ½. Therefore, the DES operating in the ECB mode imitates an ideal hashing function. Although, the keying variable may not be kept confidential, there is a possibility of keeping the variable confidential to prevent leaking scheduling information to unauthorized parties.

In the present context, the term “pseudorandom sequence” may be construed to mean a sequence of values that appear to be random but are actually deterministically computable. A pseudorandom sequence of scheduled times may be desirable to avoid unfair use of spectrum that might result from certain traffic conditions. For example, message packets may continue beyond the scheduled MST and preclude subsequent sensor nodes 12 from receiving messages. For example, in FIG. 4, as illustrated in tiling block 48, sensor node a receives a long message packet consistently that prevents sensor node d from getting traffic. Therefore, a pseudorandom sequence of scheduled times may be desirable that moves MSTs around within a frame. With a unique reference identifier, MSTs in a given frame may be determined in a computationally efficient manner. Sufficient randomness may be introduced so that sensor nodes 12 that potentially interfere with one another do not interfere over multiple consecutive frames.

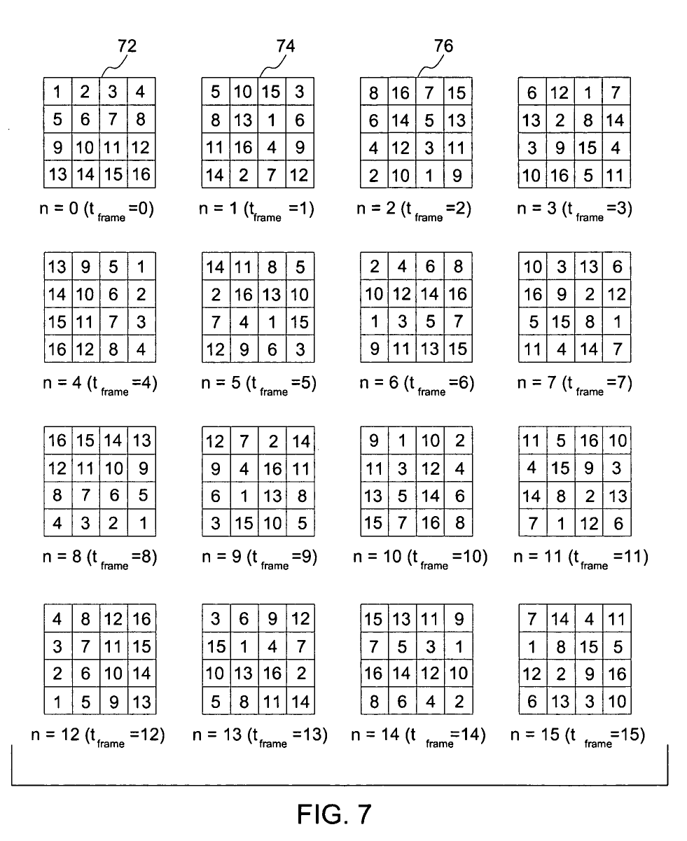

The scheme is computationally efficient to implement, and is illustrated in FIG. 7. A prime number P is selected including P-1 bins (schedule times) in the schedule set S. At a given frame interval n, the schedule time may be determined within the frame interval n+1 by multiplying the schedule time for a given schedule bin by a primitive root r in accordance with the equation:
f(n+1)=[fₛ(n)r]mod P.

For example, when prime number P=17, and 4 by 4 scheduling matrix is utilized as shown at frame n=0 (t_{frame}=0) in FIG. 7, the pseudorandom progression of schedule intervals is shown generally designated by reference numeral 72, with the cycle repeating 16 iterations. The desired effect may be achieved when scheduled time slots move around in a pseudorandom manner, and variation is achieved in both, in the interval between pairs of slots and in the sequence of which slot goes first. For example, at frame time n=0 (t_{frame}=0) 72 in FIG. 7, message slot 2 (corresponding to schedule b) immediately follows slot 1 (corresponding to schedule a). Therefore, when traffic patterns cause sensor node 12 corresponding to schedule a to receive long message packets, a non-pseudorandom schedule would prevent a sensor node 12 mapped to schedule b, from receiving data. However, at n=1 (t_{frame}=1) 74, a wider separation, 5 and 10, exists between these schedules. This separation increases at n=2 (t_{frame}=2) 76 and n=3 (t_{frame}=3), in each case making it less likely that traffic coming across schedule a could interfere with traffic for schedule b. At times n=(t_{frame}=) 4, 5, 7, 8, 9, 10, 11 and 15 the order is reversed, as shown in FIG. 7, and here it is more likely that traffic from schedule b could interfere with a.

This pseudorandom approach prevents an ongoing stream of traffic between two or more sensor nodes 12 from starving sensor nodes 12 that have adjacent schedules. If the carrier senses a message packet in progress (the length of which extends past the scheduled MST) preventing a desired transmission for a complete receiver on-time, the pseudorandom schedule makes successful transmission on the next likely scheduled receiver on-time. It may be noted that pseudorandom sequence of progression, illustrated in FIG. 7, may be computed using transition function f(n+1)=[5fₛ(n)]mod17. Similarly, MSTs in each frame may be computed by the function:
t_{i,j,t,frame}^{sub-frame}=f(i, j, t_{frame})=p·mod{f(i, j,t_{frame}−1),q}=5·mode (f(i−1),17).
A given sensor node 12 can update its schedule for the next frame time by a simple multiplication with mod operation.

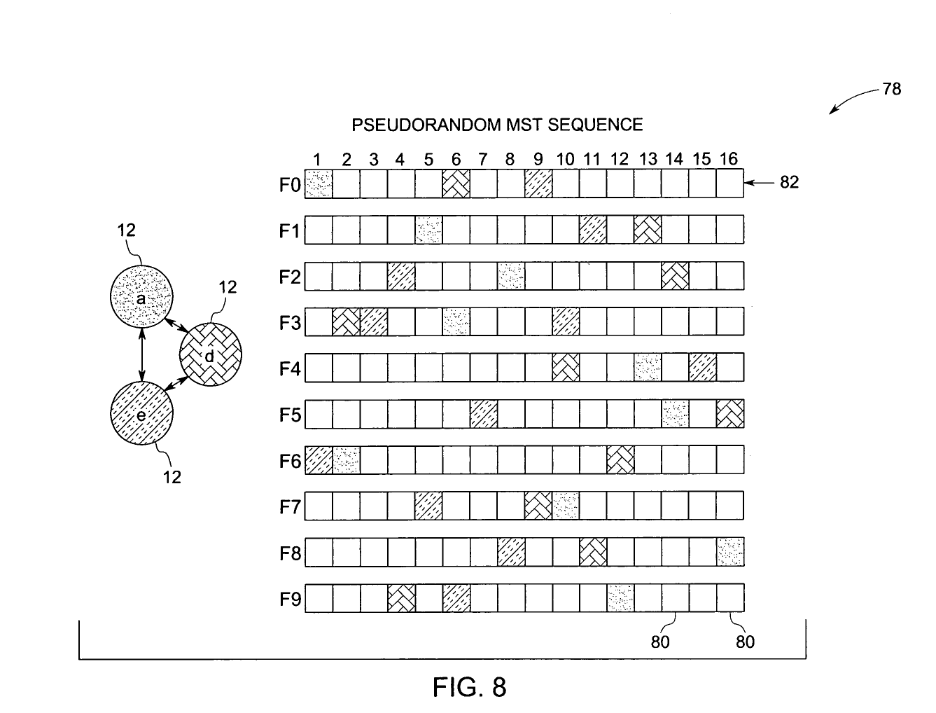

FIG. 8 illustrates the movement of the relative start times assigned to a given node to different parts of subsequent frames, as described with respect to FIG. 7. This approach prevents node starvation. FIG. 8 shows a pseudorandom MST sequence 78, in which time slots 80 within a frame 82 travel in subsequent frames 82 (e.g. F0 through F9). Three nodes a, d, and e are assigned time slots 1, 6, and 9 respectively in frame F0. In frame F1, nodes a, d, and e may be assigned time slots 5, 11, and 13 respectively based on the pseudorandom scheduling algorithm described in FIG. 7 and the equation described above.

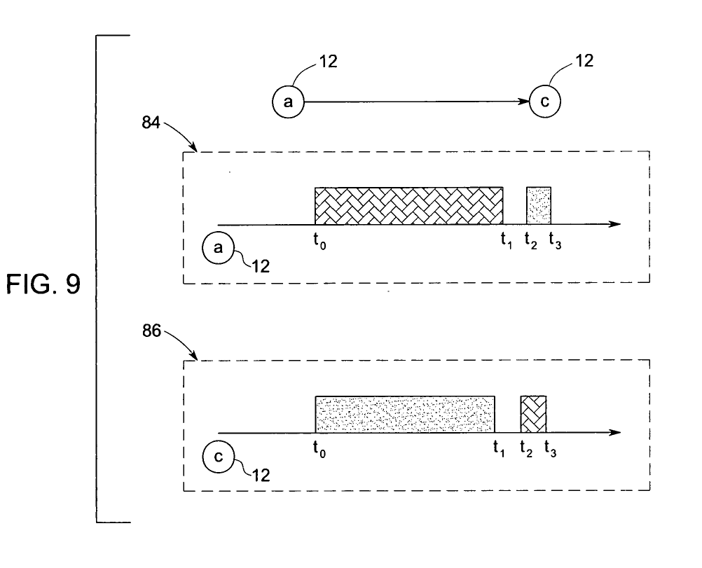

FIG. 9 is a schematic diagram illustrating “boomerang acknowledgements” for reliable message packet delivery. An acknowledgement message may be sent for any transmission via a packet transmitted during scheduled MST of the destination sensor nodes 12. However, this approach may involve considerable messaging or an intolerable delay for some applications. To maximize energy efficiency an initial “message received” acknowledgement may be sent from the receiver 12 back to the transmitter 12 immediately after the end of the message has been detected.

For example, in FIG. 9, message transmission by sensor node a is designated by reference numeral 84. At MST t₀, sensor node a transmits a message packet that continues until t₁. Between times t₂ and t₃, sensor node a remains powered up for reception of an acknowledgement message from sensor node c. Substantially concurrently, as illustrated by reference numeral 86, at time t₀, sensor node c receives the message packet sent by sensor node a. After sensor node c detects the end of message packet at time t₁, at time t₂, sensor node c transmits the acknowledgement message to sensor node a. Another advantage of the adaptive connectionless scheduling approach is a reduction in collisions due to the spreading of channel access across the entire frame.

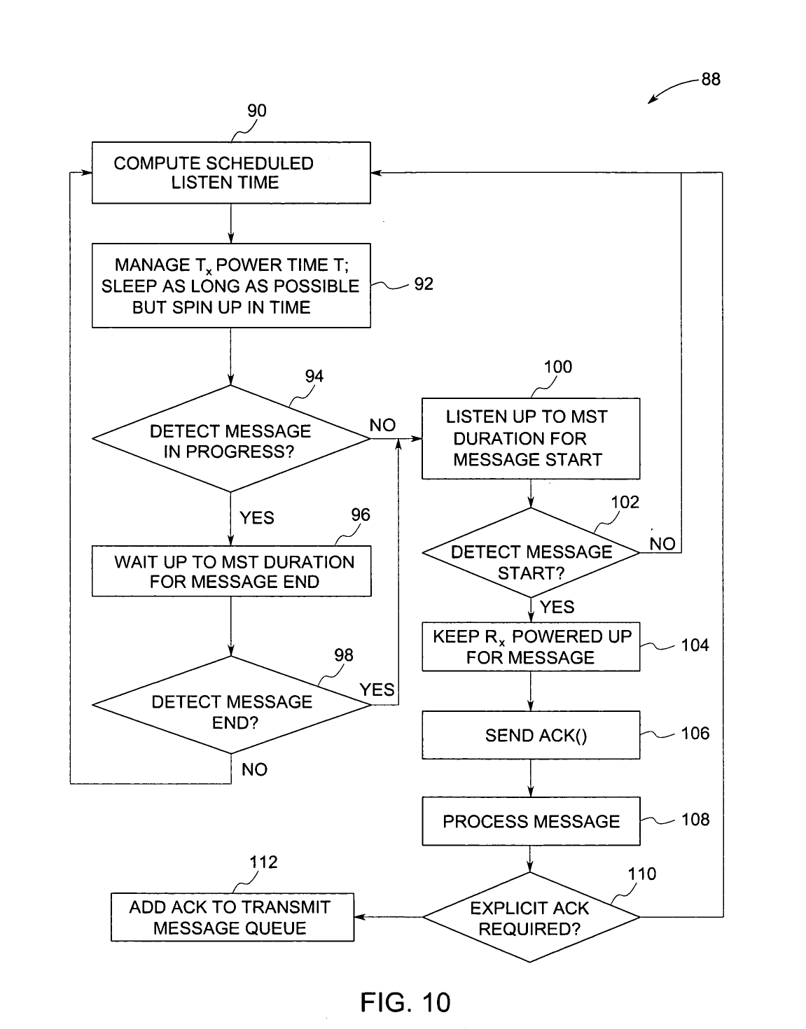

FIG. 10 is a flow chart illustrating an energy management process 88 during reception of a message packet. Sensor node 12 computes scheduled reception time (block 90) based on frame time, reference schedule, and mode. Sensor node 12 further ensures that node 12 is powered up for the scheduled time T (block 92). If progress of a message packet is detected (block 94), the sensor node 12 waits up to the duration of the scheduled MST duration for end of the message (block 96). However, if no message packet is detected (block 94), or when message end is detected (block 98), sensor node 12 remains powered up for MST duration for any message start (block 100). At block 98, until the message end is detected, steps 90 through 98 continue iteratively.

If no new message occurs during the scheduled MST (block 100), the receiver 12 powers down. If a new message is detected at block 102, during the scheduled MST interval the receiver 12 stays powered up (block 104) through the duration of the message and sends an acknowledgment (blocks 106-112) when the end of the message is detected. The acknowledgment is sent by processing the message (block 108), checking for a need for the acknowledgment (block 110) and appending the acknowledgment to the message queue (block 112). However, if no message is detected at block 102, or no explicit acknowledgment is required at block 110, the process proceeds by computing another scheduled listen time at block 110. This process allows a message acknowledgment to be received in a timely manner without requiring an extra receiver spin-up time. The transmitter 12 can assume the message was received correctly unless an explicit unacknowledged message is transmitted from the destination node 12 during the originator's 12 next scheduled receiver on-time. In this manner, latency may be controlled, without wasted messaging, and power losses.

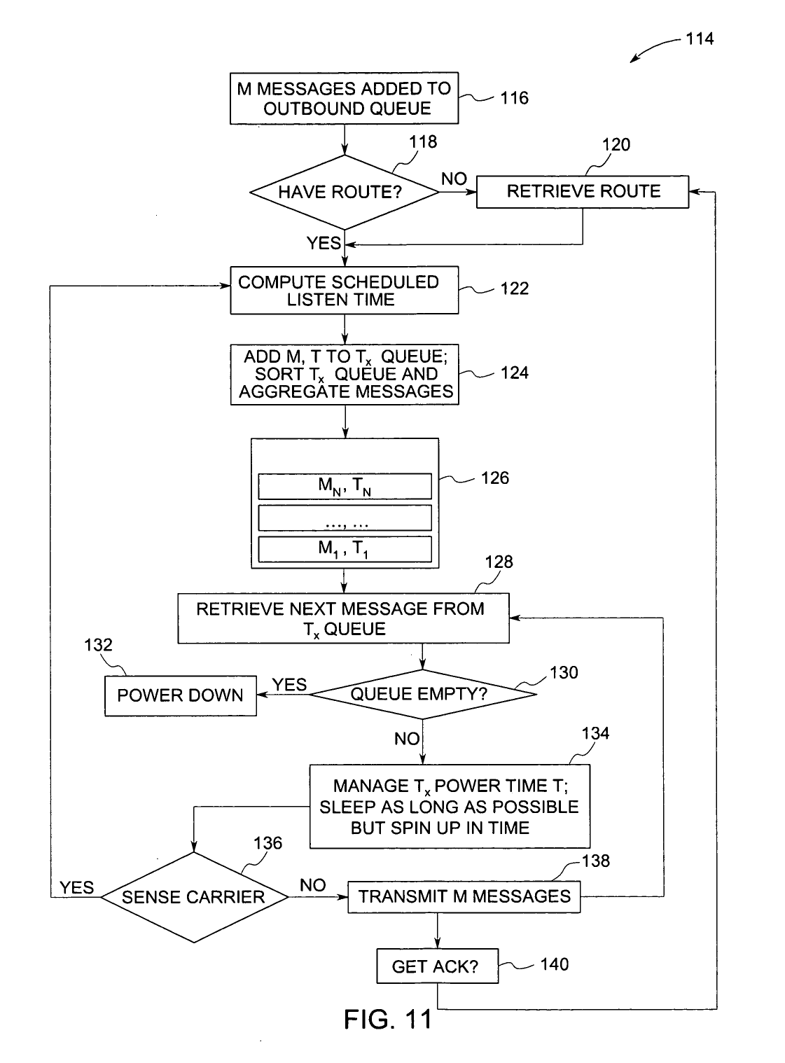

FIG. 11 is a flow chart illustrating a one-to-one transmitter power management process 114 during transmission of messages. M messages are added to an outbound queue (block 116). Routing information is checked for availability at block 118. If no routing information is available in block 118, the routing information is retrieved (block 120). Scheduled transmission times are computed based on next hop routing information (block 122). The M messages are appended along with the power up time T in the transmitter queue (block 124). The messages are sorted and aggregated based on schedule time (block 124) to generate the queue shown in block 126. The next message is retrieved from the transmitter queue (block 128). The message queue is checked for queued messages in block 130. If there are no more messages, the sensor nodes 12 are powered down (block 132). However, if there are more messages, sensor node 12 is powered up for the scheduled time T (block 134). Carrier is sensed for messages at block 136, and if a message is detected, the process again starts computing scheduled transmission time from block 122. CSMA (carrier sensing multiple access) media access may be implemented at the scheduled transmission time. The transmitter 12 waits for the acknowledgement message and if access is achieved, all M messages are transmitted (block 138) by following operations in blocks 128 through 138, and acknowledgment is checked (block 140), when all M messages are transmitted. If carrier sense prevents access at block 140, a new schedule time is attempted from block 120.

The adaptive connectionless scheduling protocol (ACSP) as described above includes several advantages. The distributed network 10 employs pseudorandomly scheduled receiver (wakeup) times for a plurality of sensor nodes 12 based upon a unique identifier, which promotes fairness in access to the network for transmission and receipt. The distributed network 10 further employs use of scheduled receiver (unicast message) start times and interleaved scheduled transmitter (multicast message) start times, as best illustrated in FIG. 3. The “short” MST intervals used permits sensor nodes 12 to sleep, based on clock accuracy across the network, time of flight ambiguity, and the amount of time a receiver node requires to detect a message. This is related to the “tiling” shown in FIG. 5, in which, for example, each node gets four tiles dispersed over the frame time. The ACSP also allows overlapping of messages with receiver start times. This illustrates the adaptive use of start times based on latency requirements of the distributed network 10 and network load. For example, thirty-six time slots may be available to a sensor node 12 during a frame, but only a subset of time slots may be used that are needed. Therefore, this approach features utilization of most of the assigned MSTs in a frame for reducing the interval between MSTs, thereby increasing bandwidth availability and improving latency. However, more “tiles” may be used if a transmission requires the bandwidth. As described with respect to FIG. 8, “boomerang acknowledgements” may be utilized to ensure that a sensor node 12 stays “awake” during a message interval long enough to receive a confirmation from a destination node. The ACSP allows self-synching based on scheduled multicast transmission duration. For example, if a sensor node 12 does not have an accurate time, the sensor node 12 can rely on the time known to another sensor node 12. Reuse of schedules based on range (or distance between the nodes 12) is also possible. In other words, a sensor node 12 that requires more bandwidth may use a schedule of another sensor node 12 closer to it if needed. This approach provides balance between increased bandwidth and increased potential for conflict between the transmitting nodes 12. The plurality of nodes utilizes collision avoidance technique known in the art, or a multiple access scheme, such as code division multiple access scheme (CDMA) for increasing the probability of successful packet delivery.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for transmitting messages among a plurality of nodes, comprising:
a media access scheduler for pseudorandomly scheduling discrete message start times for each node of the plurality of nodes to provide access to a shared medium.

2. The system as recited in claim 1, wherein the plurality of nodes comprises a plurality of wireless sensor nodes.

3. The system as recited in claim 1, wherein the media access scheduler is configured to schedule time intervals based on a parameter of each node of the plurality of nodes.

4. The system as recited in claim 3, wherein the parameter comprises a location identifier for each node of the plurality of nodes and a schedule mapping is performed based upon the location of each node.

5. The system as recited in claim 4, wherein each node of the plurality of nodes is operable to retrieve the geographical location of at least one node of the plurality of nodes.

6. The system as recited in claim 3, wherein the plurality of nodes is operable to synchronize their start times based on the parameter and the message transmission sequence of at least one node of the plurality of nodes.

7. The system as recited in claim 3, wherein the parameter comprises a unique identifier for each node of the plurality of nodes and a schedule mapping is performed based upon the unique identifier that is computed based on a hashing function via a block cipher function.

8. The system as recited in claim 1, wherein the message start times for at least one node of the plurality of nodes is configured to schedule messages received by the at least one node or schedule messages transmitted by the at least one node.

9. The system as recited in claim 1, wherein each node of the plurality of nodes switches scheduling of the message start times between a transmission mode and a reception mode.

10. The system as recited in claim 1, wherein at least one node of the plurality of nodes comprises a scheduled receiver operable to provide a scheduled receiver start time.

11. The system as recited in claim 10, wherein the plurality of nodes is operable to overlap messages with the scheduled receiver start times.

12. The system as recited in claim 10, wherein the scheduled receiver start times are separated by a time interval sufficient to allow at least one node of the plurality of nodes to enter a power saving mode.

13. The system as recited in claim 1, wherein the message start times for each node of the of the plurality of nodes are shared among the plurality of nodes based on a latency requirement of a distributed network of the plurality of nodes or a throughput of the distributed network or a distance between the plurality of nodes in the distributed network.

14. The system as recited in claim 1, wherein the message start times for each node of the plurality of nodes are shared among the plurality of nodes based on accuracy of a clock signal.

15. The system as recited in claim 1, wherein at least one node of the plurality of nodes comprises a scheduled transmitter operable to provide an interleaved scheduled transmitter start time.

16. The system as recited in claim 1, wherein each node of the plurality of nodes is operable to remain in a receiver mode until an acknowledgement from a destination node is received.

17. The system as recited in claim 1, wherein each node of the plurality of nodes is operable to remain in a receiver mode after a transmission by the respective node to await an acknowledgement based on a minimum expected message size of the acknowledgment.

18. The system as recited in claim 1, each node of the plurality of nodes is operable to remain in a receiver mode after a scheduled message start time based on an amount of time for the respective node to reliably detect presence of at least one of the plurality of messages.

19. The system as recited in claim 18, wherein each node of the plurality of nodes remains in the receiver mode for a duration that is increased if a message is detected.

20. The system as recited in claim 1, wherein the plurality of nodes utilizes collision avoidance for increasing a probability of successful packet delivery.

21. The system as recited in claim 1, wherein the plurality of nodes utilizes a multiple access scheme for increasing the probability of successful packet delivery.

22. The system as recited in claim 21, wherein the multiple access scheme comprises code division multiple access scheme.

23. The system as recited in claim 1, wherein the message start times are configured to achieve bounded latency.

24. The system as recited in claim 23, wherein the bounded latency is achieved by forwarding the plurality of messages in one or more desired directions.

25. The system as recited in claim 1, wherein the message start times are based on a square grid, a rectangular grid, a hexagonal grid, or any combinations thereof.

26. The system as recited in claim 1, wherein the message start times are selected such that the plurality of nodes within an area is assigned unique message start times from a set of all possible message start times comprising a frame.

27. The system as recited in claim 26, wherein a subset of the message start times is utilized from the assigned unique message start times assigned to a given node or set of nodes.

28. A device for scheduling messages exchanged among a plurality of nodes, comprising:
a media access scheduler for pseudorandomly scheduling discrete message start times for each node of the plurality of nodes to provide access to a shared medium.

29. A method for scheduling messages in a distributed network, comprising:
scheduling discrete message start times pseudorandomly to provide access to a shared medium for each node of a plurality of nodes based on a parameter.

30. The method as recited in claim 29, comprising receiving a plurality of messages wirelessly.

31. The method as recited in claim 29, comprising computing message start times for a schedule bin via a primitive root.

32. The method as recited in claim 29, wherein scheduling discrete message start times pseudorandomly comprises either providing a scheduled receiver start time for each node of the plurality of nodes or sharing the message start times for each node of the plurality of nodes based on a latency requirement of the distributed network.

33. The method as recited in claim 32, wherein scheduling discrete message start times pseudorandomly comprises either overlapping messages with the scheduled receiver start times or allowing at least one node of the plurality of nodes to enter a power saving mode.

34. The method as recited in claim 33, wherein scheduling discrete message start times pseudorandomly comprises varying the message start time interval based on a throughput of the distributed network or sharing the message start times for each node of the plurality of nodes based on a distance between the plurality of nodes in the distributed network.

35. The method as recited in claim 29, wherein scheduling discrete message start times pseudorandomly comprises sharing the message start times for each node of the plurality of nodes based on clock signal of the plurality of nodes in the distributed network.

36. The method as recited in claim 29, comprising providing an interleaved scheduled transmitter start time.

37. The method as recited in claim 29, comprising maintaining a high power mode for the plurality of sensor nodes during a message interval until a confirmation from a destination node is received.

38. The method as recited in claim 29, wherein scheduling message start times pseudorandomly for the plurality of sensor nodes based on the parameter comprises scheduling message start times based on a geographical location or a unique identifier of each node of the plurality of sensor nodes.

39. The method as recited in claim 38, comprising retrieving the geographical location of at least one sensor node of the plurality of sensor nodes by each node of the plurality of sensor nodes.

40. The method as recited in claim 38, comprising synchronizing the receiver start times of the plurality of sensor nodes based on the geographical location of at least one sensor node of the plurality of sensor nodes.

41. A method of operating a distributed network, comprising:
acquiring a plurality of messages via a plurality of nodes; and
controlling scheduling of message start times pseudorandomly or controlling scheduling of message slots pseudorandomly for the plurality of nodes based on a parameter of each node of the plurality of nodes via a processor, wherein the processor is coupled to the plurality of nodes.

42. A system for transmitting messages among a plurality of nodes, comprising:
a media access scheduler for pseudorandomly scheduling discrete message start times for each node of the plurality of nodes to provide access to a shared medium, wherein the message start times are selected such that the plurality of nodes within an area is assigned unique message slots.

43. The system as recited in claim 42, wherein a subset of message start times is utilized from the assigned unique message start times.

44. The system as recited in claim 43, wherein the subset of message slots in which a node awakens to receive possible messages is based on a schedule mapping determined adaptively based on idle message start times over a previous interval.

45. The system as recited in claim 44, wherein the subset of message slots in which a node awakens to receive or transmit possible messages is based on a schedule mapping determined adaptively based on the schedule mapping determined adaptively based on a field carried with a first packet in a stream of data.

46. A computer readable medium for scheduling messages exchanged among a plurality of nodes, comprising:
code stored on the computer readable medium at least partially defining a media access scheduler for pseudorandomly scheduling discrete message start times for each node of the plurality of nodes to provide access to a shared medium.
